(19) United States
(12) Patent Application Publication
(10) Pub. No.: US 2005/0255817 A1
(43) Pub. Date: Nov. 17, 2005

(54) Method and device for background monitoring of an audio source

(76) Inventor: Wolfgang Edeler, Vreden (DE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/516,801

(22) PCT Filed: Jun. 13, 2002
(86) PCT No.: PCT/IB02/02173

§ 371 Date: May 31, 2005

(51) Int. Cl. H04B 1/18

(52) U.S. Cl. 455/161.1; 455/161.3

(57) ABSTRACT

The present invention relates to a method and mobile electronic device for enabling a user to simultaneously monitor two different audio signals. The mobile electronic device has a first and a second audio component for providing a first and a second audio signal, and an audio output for outputting an audio signal. The audio output is connected to said first and second audio components. The mobile device further comprises a mixer, connected between the first and second audio component and the audio output for mixing the first and second continuous audio signals to generate a mixed signal to be supplied to the audio output. The mixed signal comprises components of both audio signals so that a user can simultaneously monitor two different audio signals. An application is to enable a user to monitor an audio recording while using a mobile telephone.

This invention relates to mobile phones with integrated entertainment features, and more particularly, to such mobile phones offering a media recording and reproducing feature. More particularly the present invention relates to background monitoring of an audio source signal recorded concurrent with making a phone call.

Modern mobile telephones provide versatile operability, such as gaming and music player options. Mobile phones with integrated music players can also offer a recording feature, e.g. if the versatile phone includes a radio and a music player/recorder to record music e.g. from the radio. Such telephones such as the NOKIA™ 5510™ with a built-in radio and a built-in MP3 player/recorder does not offer an option to record and make phone calls simultaneously.

Other efforts of phones with integrated music players/recorders are described in the German document DE 100 30 202 C2 and in WO 00/70896. Both documents describe mobile phones with built-in MP3 players and methods to transfer MP3 data to the phone. In case of the document DE 100 30 202 C2, the transfer is performed via a cable connector and e.g. via a personal computer (PC) and via a cable connector. Thereby the data are transferred as packets and it is not necessary to survey or monitor the data transfer. In the document WO 00/70896 basically the same procedure is described with the difference, that the wired connection is replaced by a wireless connection such as Bluetooth.

The advantage is that the MP3 data are transferred without a need or possibility to monitor the data transfer, because in the case of the reception of a short message, the amount of data is known and the mobile phone can detect if the download is complete.

Both documents DE 100 30 202 C2 and WO 00/70896 fail to teach a possibility to record sound or music data directly from a received sound, audio signal, or audio data stream. The only possibility to record audio data directly from an audio signal is described in the manual of the NOKIA™ 5510™ mobile phone.

The NOKIA™ mobile phone 5510™ provides no possibility to operate the audio recorder and the mobile phone simultaneously. In case of an incoming phone call during a recording of an audio signal, the recording process is interrupted with the taking of the phone call.

It would be desirable to have a mobile electronic device or a mobile phone which offers a possibility to simultaneously listen or record music or audio data, even if a phone call is to be made.

It is desirable to have a method and a device capable of recording from an audio source during active phone calls without disturbing the recording and with a possibility to monitor the recording during the active phone call with the same headset.

According to one aspect of the present invention a mobile electronic device, especially a mobile communication device or mobile terminal, is provided having first and second audio components and an audio output and being characterized by a mixer. Said audio components are for providing respective first and second continuous audio signals. Said audio output is for outputting said first and second audio components to/via an electro-acoustic transducer such as a loudspeaker or headphones. Said mixer connected between said first and second audio components and said audio output is adapted for mixing said first and said second continuous audio signals to generate a mixed signal to be supplied to said audio output.

It may be noted that the audio output can comprise a built-in loudspeaker, an audio connector for connecting external loudspeakers such as headphones or amplifiers. In contrast to the state of the art a mixed signal is transferred to the headphones , as opposed to having only either the one or the other signal. So with the present invention it is possible to monitor simultaneously two acoustic signals of a mobile electronic device. Recording from an audio source concurrently or simultaneously with active phone calls is possible without disturbing the recording by monitoring the record during the active phone call with the same headset. Said mixing can be performed in accordance with (pre-) determined signal amplitudes, in accordance with a predetermined ratio or in accordance with a predetermined amplitude ratio, and in accordance with predetermined thresholds for minimum and maximum amplitudes.

According to another embodiment of the invention, said mobile electronic device is further comprising a component for determining the amplitudes of said first audio signal and said second audio signal. So with the help of said component the device can on one hand determine if there are audio signals delivered and on the other hand can determine the amplitudes of said two signals. The component enables the device to operate the mixer as a simple shift key connecting the one or the other audio source to the audio output. The component enables the device to operate the mixer in accordance with the absolute signal amplitudes to derive an amplification factor for mixing both signal to a mixed signal.

In another embodiment of the present invention said mixer further comprises means for adjusting the ratio of amplitudes of said first and second audio signal in said mixed signal. This can simplest be implemented by a fixed ratio mixer, wherein both signals are amplified with a predetermined and fix amplification factor. A more sophisticated solution can be to mix the signals in accordance with a predetermined ratio of amplitude, independently of the actually delivered signal strengths of both audio signals. This embodiment can be implemented as automatic gain control circuits known from the field of radio transceivers. The predetermined amplitude ratio and the automatic gain control can prevent that the phone signal is drawn out by a loud passage in the monitored audio signal. A second advantage is that it is guaranteed that even very quiet passages in the background monitoring can be perceived by the user.

In yet another embodiment of the invention, at least one of said audio components comprises an input terminal for an audio signal. This is a connector for coupling to an external audio source such as a radio, a CD player, a cassette player or even a record player to record audio data from an arbitrary audio source. Such connectors are known as “line in” socket of audio devices. In the simplest case, mobile electronic device is just an electric element that is to be branched in between single headphones or a headset and multiple audio sources. Such a branch in device may also provide e.g. a remote control functionality, to enable a user to simultaneously operate a number of devices being distributed e.g. over a few pockets of a jacket or being incorporated in a suitcase or a clothing element. So using such a multi-to-one connector a user can use a gaming device, listen to a radio station in the background, and can even take phone calls. It may be noted, that the audio connector can be a standard audio connector such as a 3.5 mm headphone connector, can be an optical connector to receive a optical digital signal as known from digital HI-FI audio components, or can be a computer hardware interface connector as known from the technical field of computer technology.

In another embodiment of the present invention one of said audio components comprises a radio receiver. The radio receiver is a simple and well known device that provides a continuous audio data stream. A simple embodiment of the invention can be a branch in radio equipment for a mobile phone headset. The branch in radio is equipped with the mixer to enable a user to monitor a radio transmission even during monitoring another audio source. As example a user may listen to a sports report and simultaneously make a phone call.

According to another embodiment of the present invention one of said audio components is comprising an audio player. The use of a pure audio player provides only a slight advantage, as playing stored audio data can be repeated nearly inventively, and the playing can be interrupted by the “Pause” key, and can be replayed from the paused point without a loss of information or the waste other resources.

In yet another embodiment of the invention, one of said audio components comprises an audio recorder. So if the electronic device or the audio player also includes an audio recorder, an audio data stream can be recorded, and monitored during said recording, and simultaneously another audio date source can be surveyed. It may be noted, that the performance of the present invention the better the more different the first and the second signals are. For example, a speech signal from a communication device, a music signal and a baby phone can be combined as the three signals that are to be expected are so different, that a user can simply relate the audio signal to the respective audio source.

According to another embodiment of the present invention, said audio recorder is comprising a component for generating a signal indicative of the recording state of said audio recorder. Conventionally, such a signal is fed to a LED to indicate that a recording is in process. The signal can be used to indicate to the mixer that a recording is in process.

In another embodiment of the present invention said mixer comprises a component to receive a signal indicative if one of said audio signals of said audio components is actually recorded or not, and a component for adjusting the ratio of amplitudes in accordance with said received signal. The recording signal provides a kind of priority to the mixer that is indicative of a proposed importance of said audio signal for a user. The signal can be used to expand the functionality of audio devices so in the case of a phone/radio recorder combination, a simple “phone first” circuit can be expanded to a “phone first”, “recording second” and “radio last” circuit. The received signal can a standard AC or DC Voltage signal, a code notification, or even the absence of a signal like absolute low/GND or the like.

In yet another embodiment of the present invention one of said audio components comprises a mobile phone. In case of a telephone application, the phone downlink of a mobile telephone is one of the signals to be mixed. The other signal can be an audio signal from a recording that needs to be monitored. Another signal to be mixed can be an alarm from an alarm clock incorporated in said mobile phone. The use of an embodiment of the invention for mobile telephones has the additional advantage that features like hands-free conversing features may be used to simultaneously phoning and audio monitoring of a background application. This feature may be used in connection with car radios supporting a hands-free conversing or a mobile phone, so a front seat passenger may monitor the recording of music from the car radio even if the driver is simultaneously using the mobile phone in a hands-free conversing mode, via the audio system of the car radio.

In another embodiment of the present invention, one of said audio components comprises a component for coding/decoding audio signals. This application can be a useful feature, if a digital recording is wanted, or if a MP3 file is to be played, or recorded from a digital or analogue audio source. Here it may be noted that the mixer can be an analogue or a digital mixer, depending on the actual design of said mobile terminal device.

Conveniently, said audio output comprises an audio connector for connecting headphones. Headphones have the advantage that background noise can be reduced in case closed ear-pieces are used, so a user has to monitor only two different audio signals. In the case of a mobile phone, the headphone can be part of a headset and can further comprise a microphone or even a remote control to provide full telephone headset operability. It may further be noted that a headphone with separate loudspeakers for both audio sources in at least one ear-piece will also fall within the scope of the present invention, as the mixing of the both audio signals may be done acoustically. A two loudspeaker solution falls under the scope of the present invention if components are provided to change the audio signal strength in accordance with the presence of two different audio signals.

According to another aspect of the present invention, a method for mixing a first and a second audio signal with different priorities is provided. The method comprises receiving of a first and a second audio signal, mixing of said first and said second audio signal in accordance with a predetermined ratio of amplitudes, and providing of said mixed signal for connection.

The method can be used especially for computer devices, wherein the first and second audio source come from different modules within one single element. The elements can be a personal computer with different application such as a MP3 player/recorder which may be combined with a CD recorder, and e.g. a telephone module a radio receiver module or any other modules/applications with a built in audio output/notification functionality.

It may further be noted that the present invention is not restricted to only two audio sources, so in the case of a communicator with an implemented radio recorder, the present invention can be used to mix signals from a phone, a radio recorder and a software application such as a text program, so it is possible to phone record and write simultaneously.

In another embodiment of the present invention, the method further comprises detecting a first and a second audio signal, prior to said step of mixing. The detection can be used to detect if a signal is present or not, and can therefore be used to determine if an explicit mixing step is necessary or not. The detection of the signal can include the detection of single properties of the signals such as amplitude, frequency spectrum or the like.

According to another embodiment of the present invention, the method further comprises the determination of the amplitudes of said first and second audio signals. The detected amplitudes can be used to fix a ratio of amplitudes in said mixed signal. This can help to supply a mixed signal to the user providing a maximum of information. Thereby, it can be prevented that one of said signals is downed out by the other.

In another embodiment of the present invention, the method further comprises coding and/or decoding of at least one of said first or second audio signals. The coding can be used to convert analog signals to digital data and vice versa. The coding can be used to convert audio signals and digital data to another data format such as MP3 and vice versa. The present invention is not limited only to MP3 but can be applied to any arbitrary audio data format.

According to another embodiment of the present invention, the method further comprises recording of at least one of said audio signals. Said recording may be executed by storing coded or decoded audio signals.

Conveniently, said method further comprises generating of a signal indicative of a proceeding storing operation. Conventionally, such a signal is generated to indicate that the device is actually recording and that a user input may interrupt the recording process.

According to another embodiment of the present invention, the method further comprises detecting of a signal indicative of a proceeding storing operation, and mixing of said first and second signals in accordance with said detected signal. Such an embodiment can include a functionality to suppress the music signal if the music signal is actually not recorded, and therefore requires no monitoring. This feature can be used to relate the mixing properties such as the amplitude ratio to the signal, to an expected importance for the user, which can be derived from the information whether said signal is recorded or not.

According to another aspect of the present invention, a computer program tool is provided for executing said method for mixing audio signals in an electronic device. Said computer program tool comprises program code means for carrying out the method of the preceding description when said program toll is run on a computer or an electronic device.

According to yet another aspect of the invention, a computer program is provided comprising program code means for carrying out the method for mixing signals in electronic devices of the preceding description when said program product is run on a computer or an electronic device.

According to another aspect of the present invention, a computer program product is provided for executing said method for mixing audio signals in a mobile electronic device. Said computer program product comprises program code means stored on a computer readable medium for carrying out the method of the preceding description when said program is run on a computer or an electronic device.

In the following, the invention will be described in detail by referring to the enclosed drawings in which:

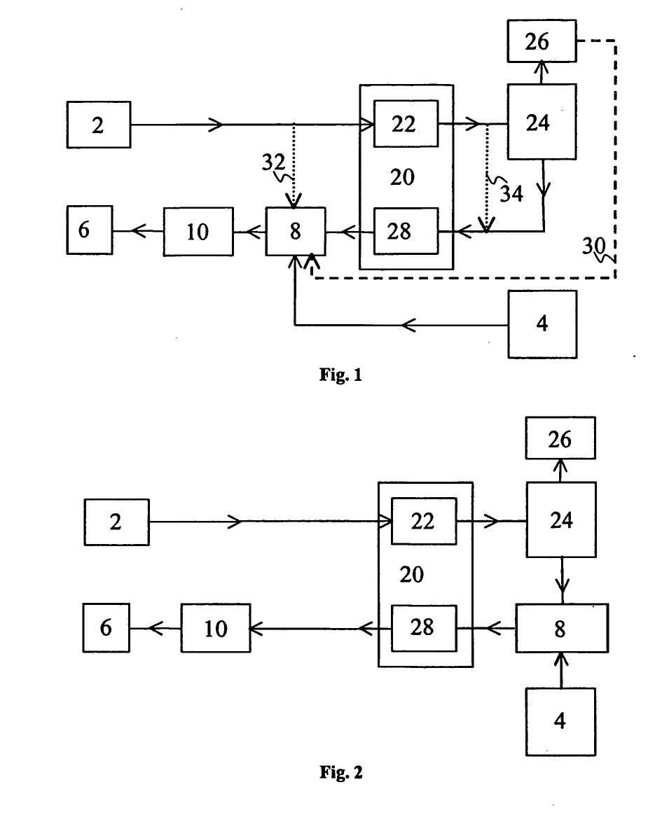

FIG. 1 is a block diagram of a mobile electronic device according to one embodiment of the present invention,

FIG. 2 is a block diagram of a mobile electronic device according to another embodiment of the present invention, and

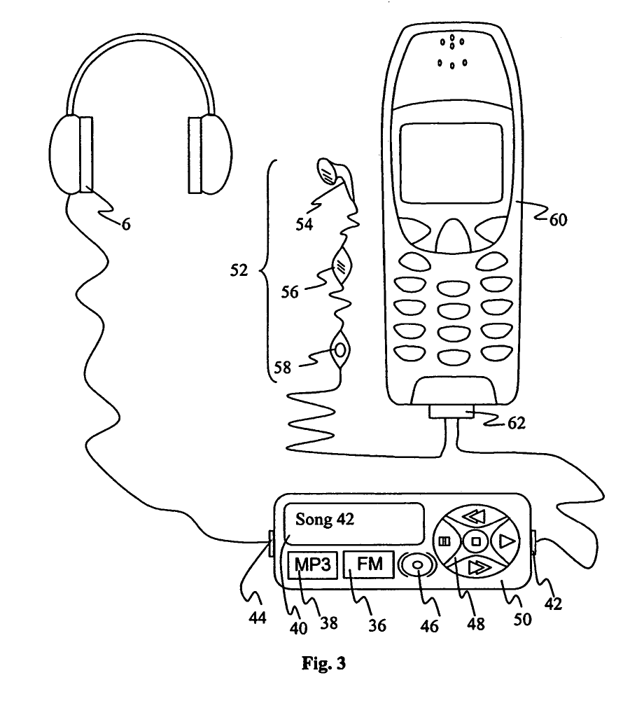

FIG. 3 is a schematic depiction of two mobile electronic devices according to two different embodiments of the present invention.

FIG. 1 is a block diagram of a mobile electronic device according to one embodiment of the present invention. The mobile device includes an audio source 2 that can be a radio or an external audio source. The audio source 2 is providing a continuous audio data stream, as known from the radio. The audio data stream is typically unstructured, so if a user wants to record audio data such as a piece of music or a radio play, he has to start the recording manually. The state of the art simply interrupts the recording, as the monitoring of the audio can not longer be assured. In the present mobile electronic device the recording is performed as digital MP3 data.

For digital recording the audio data from the audio source are digitized in an analog to digital converter 22 within the analog to digital coder and decoder or codec 20. The digital audio data are processed in the digital signal processor (DSP) 24 and are transformed into MP3 data that are stored in the storage 26. As known in the state of the art, the storage 26 can be any known digital storage medium such as RAMs, hard discs and the like. The digital audio signal received by the DSP 24 or a reconverted MP3 file is returned to a digital to analogue converter 28 within the codec 20, and reconverted to an analogue audio signal and fed to the mixer 8. The mixer is also connected to a phone downlink 4. Assuming the mixer 8 receives either a signal from the audio source 2 or the phone downlink 4 the mixer 8 acts like a shift key switching the active signal to the headphone amplifier 10. This is understandable as the superposition of a signal and no signal simply results in the original signal.

If there are two signals, the mixer 8 from the audio source 2 and the phone downlink 4 generates a mixed signal that is transferred to the headphones amplifier 10. The signal from the headphones amplifier 10 is transferred to the headphones 6. The mixed signal is preferably mixed in a way that the signal from the phone downlink can clearly be perceived and the signal from the audio source 2 can be detected as a background signal.

In case of a stereo audio source 2 the stereo signal may even be transferred to only one channel of a stereo headset as a single mono signal, and the audio signal from the phone downlink 4 is transferred on the other stereo channel as a mono telephone audio signal. This solution sounds not much like a mixing process, but the signal transferred to a stereo headphones can be regarded as a mixed stereo signal.

In FIG. 1 there are also two dotted lines 32, 34 and one broken line 30. The dotted lines 32, 34 indicate shortenings in the signal path from the audio source 2 to the mixer 8. The Line 32 indicate a direct branch from the audio source 2 to the mixer 8, economizing the digital to analogue decoding in the codec 20. This shortening has the slight disadvantage that a user only monitors the input to the recorder and not the recording itself, but has the advantage that it is resource saving. Another shortening indicated as the second dotted line can be implemented between the analog to digital converter 22 and the digital to analog converter 28.

The broken line 30 indicates a control connection between the storage 26 and the mixer 8. The control connection transfers a signal indicating that a recording is in process or not. If no recording is performed, the signal from the audio source 2 can be suppressed to provide a maximum of clarity to the phone downlink 4. In this case the mixer 8 acts like a shift key switching the phone signal to the headphones amplifier 10 and suppressing the signal from the audio source 2.

In FIG. 1 the implementation is done in the analog audio signal paths, e.g. within the hardware audio codec 20. Routing and level adjustment can be done via software in the analog audio paths from the hardware codec 20.

FIG. 2 is a block diagram of a mobile electronic device according to another embodiment of the present invention. The components and the function is basically the same as in FIG. 1. The difference is that the mixer 8 is a digital mixer branched in between the DSP 24, the digital phone downlink 4 and the digital to analogue converter 28. FIG. 2 is a digital solution of the mixing architecture of FIG. 1.

In FIGS. 1 and 2, recording from an audio source 2 needs the possibility to prove what is recorded. This is known as monitoring. Monitoring is done with the headset 6. This headset 6 is also used for phone calls from the phone downlink 4. During an active phone call one can monitor the recorded audio source as background monitoring is used. In the case of an active phone call the recorded audio signal is monitored by reducing the monitored level and the phone downlink is mixed in the audio playback signal path. Because the mixing is in the audio playback path the phone call does not influence the recorded audio signal from the audio signal source. This makes it easy to control the record. The advantage from this solution is that the recording must not be stopped and the user can hear the recording all the time and can so control when he will stop recording.

FIG. 3 is a schematic depiction of two mobile electronic devices according to two different embodiments of the present invention. The two devices are a mobile telephone 60 and a radio-music player/recorder 50. Both devices are interconnected via connection cable and respective connectors 42 and 62, to the radio recorder 50 and the phone 60, respectively. It may be noted that all connection between the single elements may also be embodied with wireless connections. The connection between the phone 60 and the recorder 50 provides a visible connection between two basically different audio sources. As the functionality of mobile phones is well known, the mobile phone is not described here in more detail. The radio recorder 50 is a MP3 recorder, capable of receiving radio programs and recording from said radio on a storage medium. The radio recorder 50 comprises a display 40, two buttons for the basic functionality, one for the recorder functionality 38, and one for the radio functionality 36. In the depicted device a multi function button for the basic functionality such as “Play”, “Stop”, “Pause”, “Fast Forward/skip” “Rewind/skip”, “volume”. The recorder 50 further comprises a “Record” button 46 to record a piece of music received by the radio.

In a first scenario only the phone 60, the recorder 50 and headset 52 are used. The headset 52 comprises three elements; an in-ear loudspeaker 54, the microphone capsule 56 and the hang up control capsule 58. In this first case the inventive element is incorporated in the mobile telephone 60. A user can make phone calls via the headset and hear music from the recorder 50 via the connection to the telephone 60, and the telephone interface 62 on the earphone 54. In case that a piece of music is recorded and an incoming telephone call occurs, the user can take the call by pressing the button on the hang up control capsule 58. In this case the phone mixes both signals transferred to the earphone 54, so that the user can phone while monitoring the recording as a background sound. It is also possible to make a call while recording, or while listening to the radio.

In a second scenario only the phone 60, the recorder 50 and the stereo headphone 6 are used. In this second case the inventive element is incorporated in the recorder 50. The user can listen to music from the recorder 50, as in the case of conventional music players and when an incoming telephone call occurs, the user can take the call by pressing a button on the phone 60. In this case the recorder mixes both signals and transfers the mixed signal to the headphones 6, so that the user can listen to the phone while monitoring the recording as a background signal. If the headphones 6 has no microphone the user may hold the phone 60 as a conventional handheld microphone to speak. The use of stereo headphones has the additional advantage that the music audio signal and the phone audio signal can be used totally separately, if the phone audio signal is transferred to one stereo channel, and the music audio signal is transferred to the other stereo channel.

It may be noted, that in the present invention is not restricted to multi functional electronic devices, but can be implemented in a remote control connected to a recorder, a mobile phone, and a headset, with control elements for the recorder, the phone and the headset.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. A mobile electronic device having a first audio component for providing a first continuous audio signal and a second audio component for providing a second audio signal, and an audio output for outputting an audio signal, said audio output being connected to said first and second audio components, and
a mixer, connected between said first and second audio component and said audio output for mixing said first continuous audio signal and said second audio signal to generate a mixed signal to be supplied to said audio output,
characterized in that
said first audio component comprises a radio receiver and an audio recorder configured for receiving radio programs and recording from said radio receiver and providing a audio monitor audio signal as said first continuous audio signal, without influencing the recorded audio signal from the radio receiver.

2. The mobile electronic device according to claim 2, wherein said audio recorder comprises a component generating a signal indicative of the recording state of said audio recorder.

3. The mobile electronic device according to claim 3, characterized in that said mixer comprises a component to receive a signal indicative of whether one of said audio signals of said audio components is actually recorded or not, and a component for adjusting the ratio of amplitudes in accordance with said received signal.

4. The mobile electronic device according to claim 1, wherein at least one of said audio components comprises an input terminal for an external audio signal.

5. The mobile electronic device according to claim 1, further comprising a component for determining the amplitudes of said first audio signal and said second audio signals.

6. The mobile electronic device according to claim 1, wherein said mixer further comprises means for adjusting the ratio of amplitudes of said first and second audio signal in said mixed signal.

7. The mobile electronic device according to claim 1, wherein one of said audio components comprises an audio player.

8. The mobile electronic device according to claim 1, wherein one of said audio components comprises a mobile phone.

9. The mobile electronic device according to claim 1, wherein one of said audio components comprises a component for encoding/decoding audio signals.

10. The mobile electronic device according to claim 1, wherein said audio output comprises an audio connector for connecting headphones.

11. A method for mixing a first and a second audio signal with different priorities in a mobile device, said device comprising a radio receiver and a recorder, the method comprising the steps of:
receiving a radio program via said radio receiver,
recording said radio program at said recorder,
providing a record monitor signal of said radio program as a first continuous audio signal;
receiving a second audio signal;
mixing said first and said second audio signals according to a predetermined ratio of amplitudes, without influencing the recorded audio signal from the radio receiver; and
providing said mixed signal for output.

12. The method according to claim 11, further comprising generating a signal indicative of a proceeding recording operation.

13. The method according to claim 12, further comprising detecting a signal indicative of a proceeding recording operation, and mixing said first and second signals in accordance with said detected signal indicative of a proceeding recording operation.

14. The method according to claim 11, further comprising detecting a first and a second audio signal, prior to said step of mixing.

15. The method according to claim 11, further comprising determining the amplitudes of said first and second audio signal.

16. The method according to claim 11, further comprising decoding at least one of said first or second audio signals.

17. The method according to claim 11, further comprising encoding at least one of said first or second audio signals.

18. A computer program tool for executing said method for mixing audio signals in a mobile electronic device according to claim 11, comprising program code means for carrying out the steps of claim 11 when said program is run on a computer or an electronic device.

19. A computer program comprising program code means stored on a computer readable medium for carrying out the method of claim 11 when said program product is run on a computer or an electronic device.

20. A computer program product comprising program code means stored on a computer readable medium for carrying out the method for mixing audio signals in a mobile electronic device of claim 11 when said program product is run on a computer or electronic device.
